(19) United States
(12) Patent Application Publication
(10) Pub. No.: US 2009/0234693 A1
(43) Pub. Date: Sep. 17, 2009

(54) TRUSS AND FRAME FABRICATION METHODS AND SYSTEMS

(75) Inventors: Bernard KENNELLY, New South Wales (AU); Joseph E. FABIN, Elmwood Park, IL (US)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ILLINOIS TOOL WORKS INC., Glenview, IL (US)

(21) Appl. No.: 12/390,656

(22) Filed: Feb. 23, 2009

Related U.S. Application Data
(60) Provisional application No. 61/037,107, filed on Mar. 17, 2008.

(51) Int. Cl. G06Q 10/00; G06F 19/00

(52) U.S. Cl. 705/7; 700/160

(57) ABSTRACT

In a system and a method for managing production of prefabricated trusses and frames, production data during manufacture of a prefabricated truss and/or frame is collected, stored and processed to enable analysis of efficiency in the manufacture of the prefabricated truss and/or frame.

### FIELD OF THE INVENTION

The present invention relates to production of prefabricated trusses and frames.

### BACKGROUND OF THE INVENTION

Prefabricated roof trusses, floor trusses and wall frames are typically manufactured in factory production lines. Truss and frame sub-components are generally cut from timber stock into different lengths and end-cut geometries, and then positioned in jigs or on assembly tables to be secured together using fastener-driving tools. The variety and complexity of prefabricated truss and frame designs create problems with productivity, delay, waste, and cost.

A need therefore exists for a solution to optimise efficiency in the manufacture of prefabricated trusses and frames.

### SUMMARY OF THE INVENTION

According to the present invention, there is provided a method for managing production of prefabricated trusses and frames, the method including the steps of collecting production data during manufacture of a prefabricated truss and/or frame, storing the collected production data, and processing the stored production data to enable analysis of efficiency in the manufacture of the prefabricated truss and/or frame.

The method can further include the step of determining at least one improvement in the manufacture of the prefabricated truss and/or frame based at least in part on the processed production data.

The production data can be selected from time-based data, event-based data, activity-based data, usage-based data, and combinations thereof.

The production data can relate to at least one of productivity, delay, waste, and cost.

The present invention also provides a system for managing production of prefabricated trusses and frames, the system including at least one data logger to collect production data during manufacture of a prefabricated truss and/or frame, a database to receive and store the collected production data, and a computer programmed to access and process the stored production data to enable analysis of efficiency in the manufacture of the prefabricated truss and/or frame.

The at least one data logger can log production data from at least one machine and/or at least one work station used during manufacture of the prefabricated truss and/or frame.

The at least one machine can be selected from a fastener-driving tool, a saw, a roller, and a press. The at least one work station can be a jig or an assembly table.

### BRIEF DESCRIPTION OF THE DRAWINGS

The invention will be further described by way of example only with reference to the accompanying drawings, in which:

FIG. 1 is a flow chart of a method for managing production of prefabricated trusses and/or frames in accordance with one embodiment of the invention;

FIGS. 2 and 3 are flow charts of the method implemented in a typical roof truss prefabrication line;

FIGS. 4 and 5 are flow charts of the method implemented in a typical floor truss prefabrication line;

FIGS. 6-9 are flow charts of the method implemented in a typical wall frame prefabrication line;

FIG. 10 is a block diagram of a system for implementing the method;

FIG. 11 is a schematic diagram of a data logger used on a fastening tool used during manufacture of prefabricated trusses and/or frames;

FIG. 12 is a graph of temperature, shots per minute, and time logged by the data logger; and

FIGS. 13-17 are example screens, reports and tables generated by the method and system of the invention.

### DETAILED DESCRIPTION

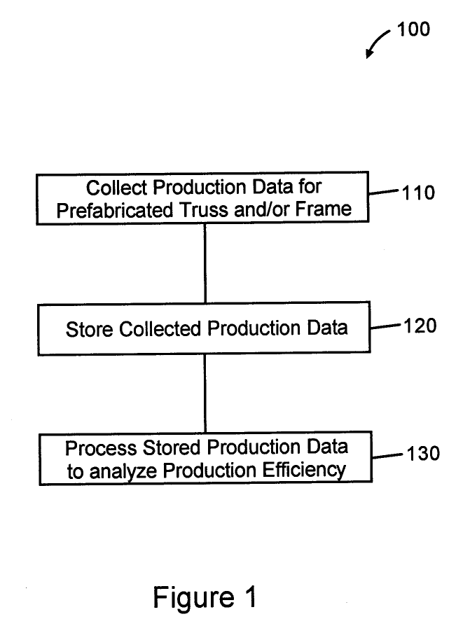

FIG. 1 is a flow chart of a method 100 for managing production of prefabricated trusses and/or frames in accordance with one embodiment of the invention. The method 100 starts at step 110 by using data loggers to collect production data relating to one or more machines, work stations, components, materials, and fasteners and/or connectors used in the manufacture of a truss and/or frame in factory prefabrication line. Machines used in the truss and/or frame prefabrication line include saws, rollers, presses, fastener-driving tools, etc. The truss and/or frame prefabrication line includes work stations such as jigs and assembly tables. The components used in the truss and/or frame prefabrication line include chords, webs, spacers, waling plates, girder boots, girder brackets, web stiffeners, chord stiffeners, straps, braces, packers, gussets, wall plates, blocks, nogs, studs, jambs, panels, etc. The materials used in the prefabrication line are raw material and waste material. The raw material is, for example, timber and/or steel stock, and the waste material is, for example, timber and/or steel off-cut. The fasteners and/or connectors used to secure the components together in the prefabrication line include nails, nail plates, staples, brads, screws, corrugated fasteners, etc. The production data collected in step 110 includes operational parameters, physical dimensions, geometries, positions, locations, activities, events, etc. associated with the machines, work stations, components, materials, and fasteners. The collected production data is time-based, event-based, activity-based, usage-based, etc.

The method 100 moves to step 120 where the collected production data is stored, for example, in comma-separated values (CSV) file format in a database accessible by a remote computer, for example, a personal computer (PC), a laptop computer, a personal digital assistant (PDA), etc. In step 130, the stored production data is processed by software, for example, a spreadsheet application executable by the PC. As described in detail below, the processed production data enables analysis of efficiency in the manufacture of the prefabricated truss and/or frame. Based on the processed production data, improvements in the manufacture of the prefabricated truss and/or frame can be determined, for example, productivity improvements, reductions in delays and bottlenecks, reductions in production/operating costs, reductions in waste, etc.

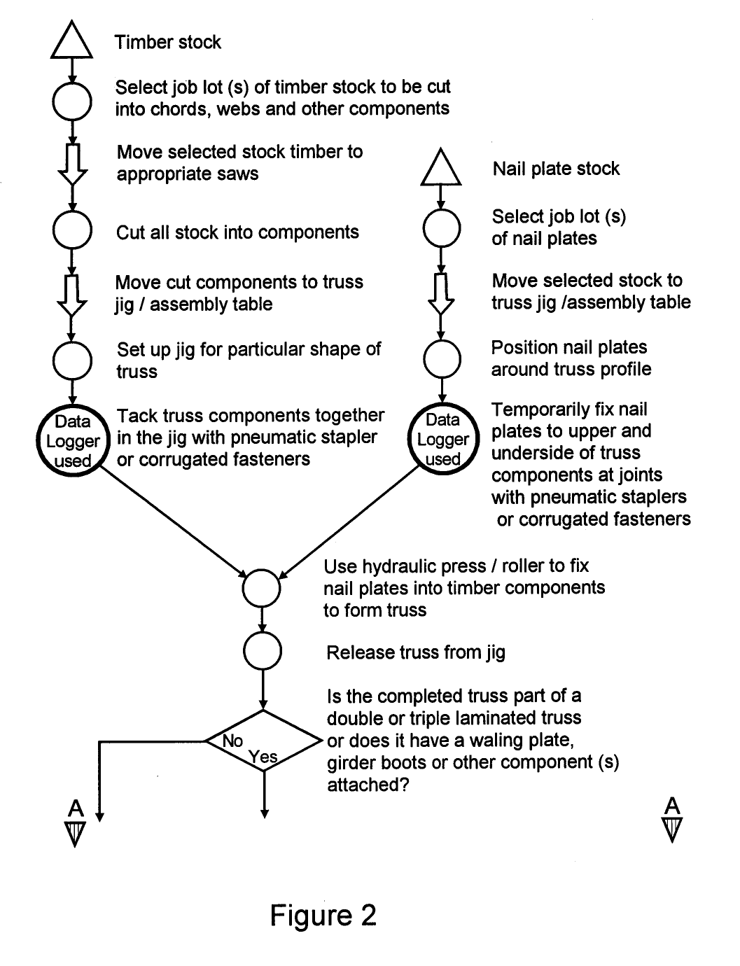

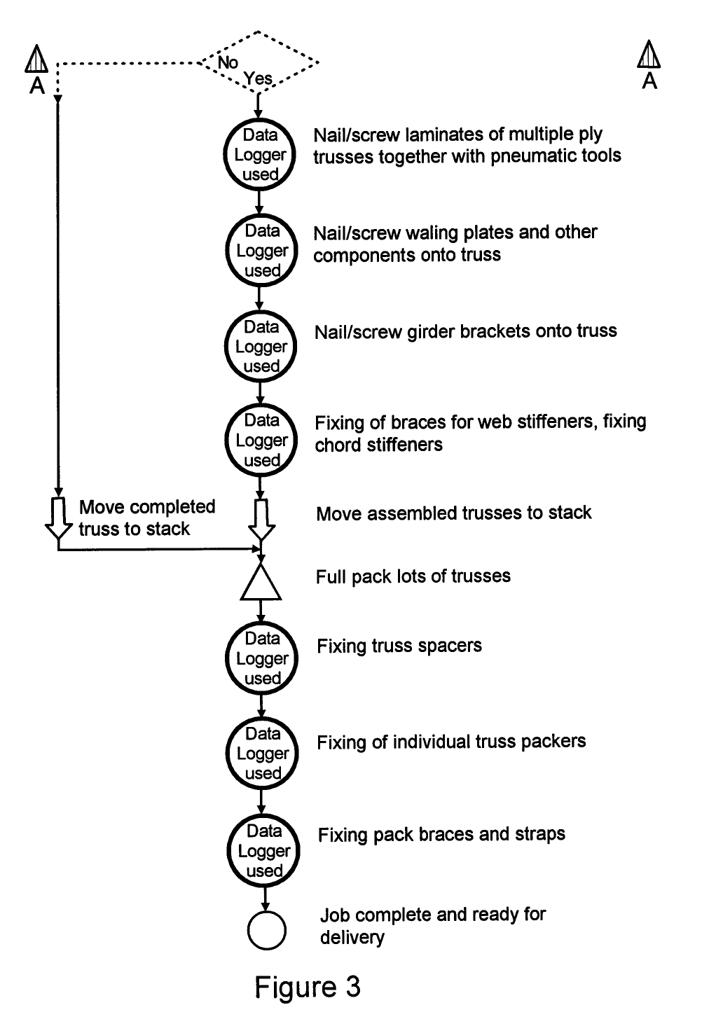

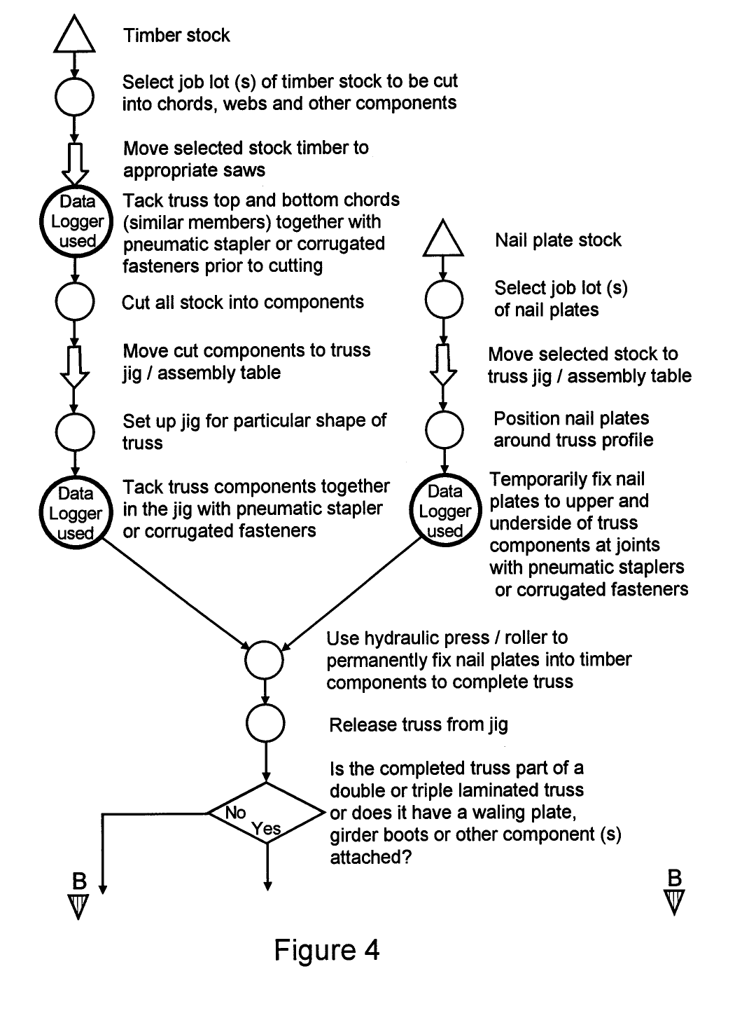

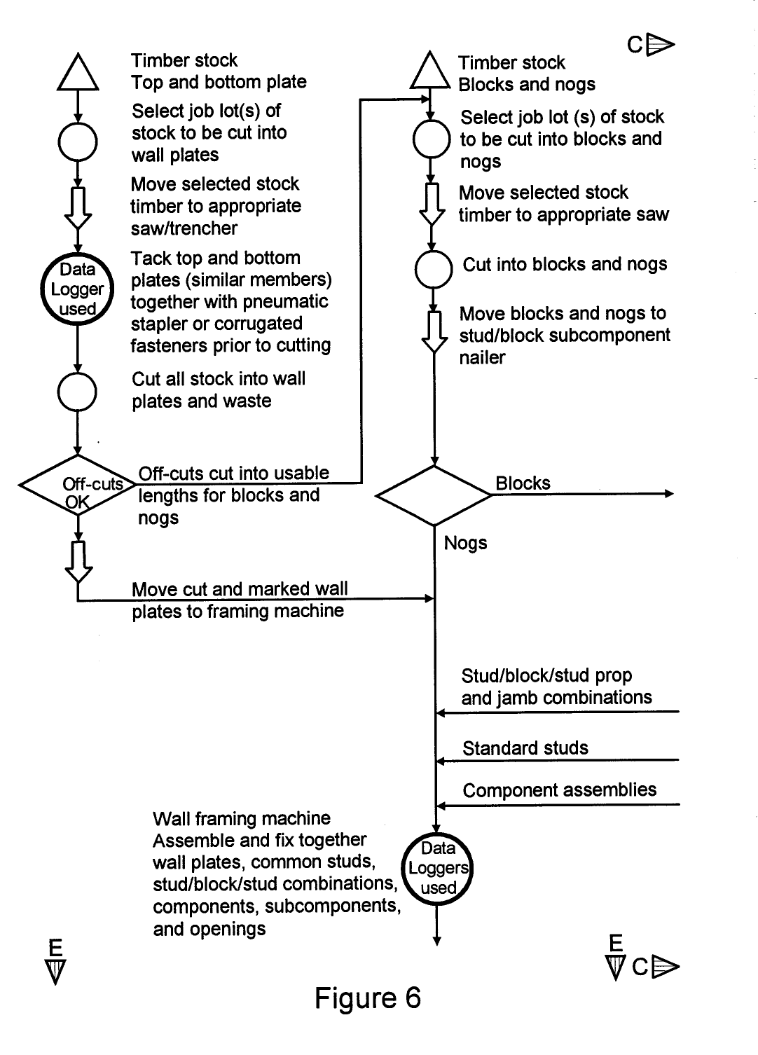

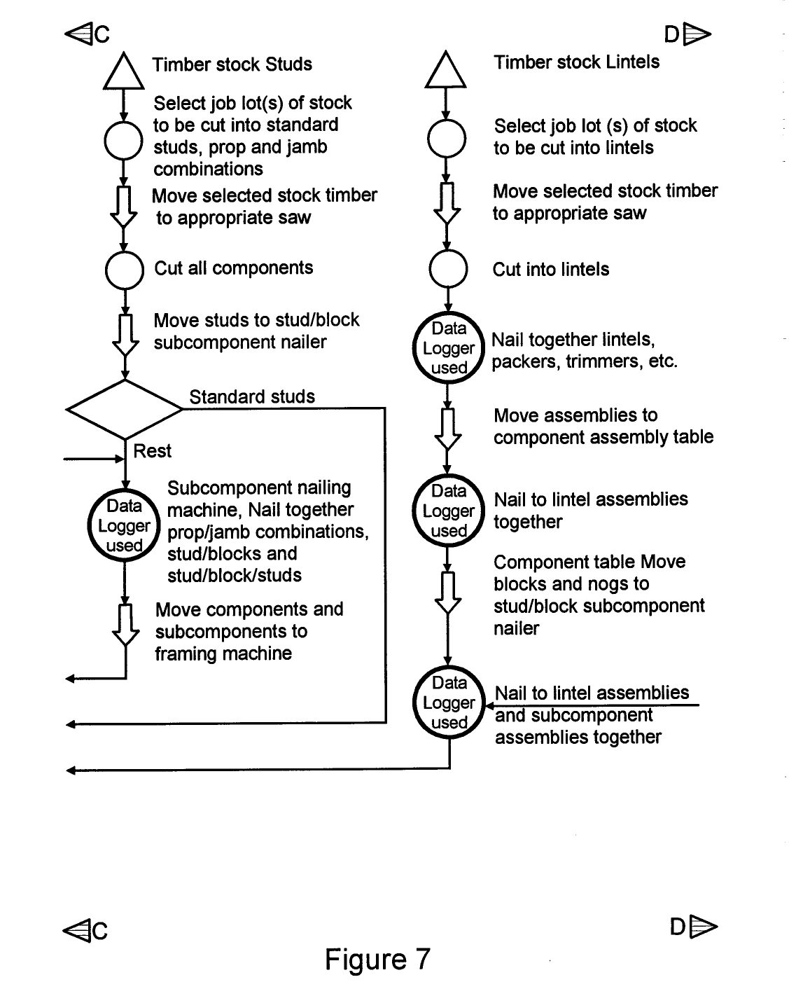

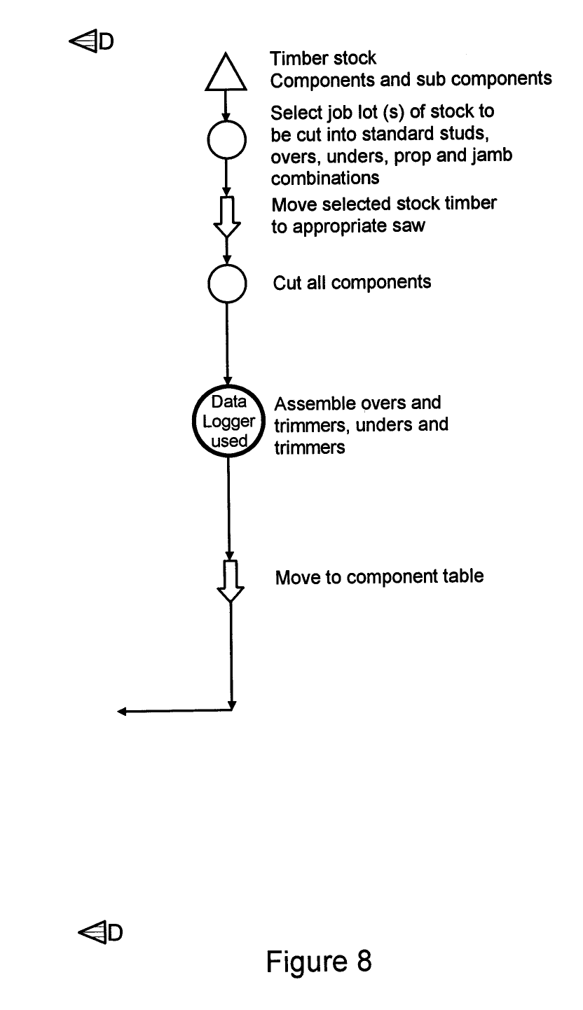

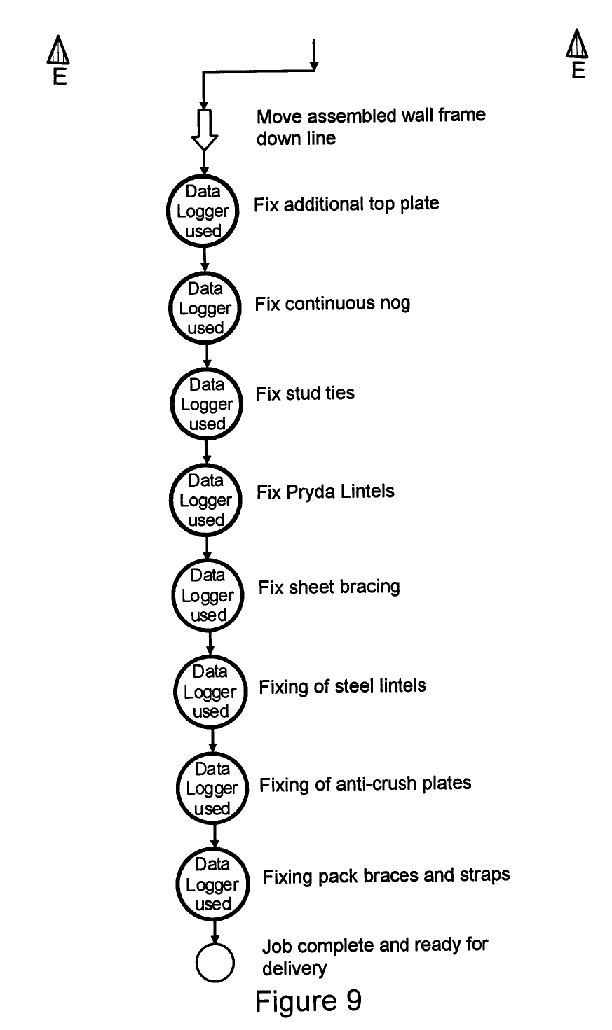

FIGS. 2 and 3 illustrate the method 100 implemented in a typical roof truss prefabrication line. Referring to FIG. 2, data loggers collect production data relating to temporary securing together of roof truss components using fastener-driving tools, for example, pneumatic staplers. The components are then permanently secured together by hydraulic presses and/or rollers to form assembled roof trusses. Referring to FIG. 3, data loggers also collect production data relating to assembly of multiple-ply and multi-component roof trusses using fastener-driving tools. Data loggers then collect production data relating to pre-delivery processing of assembled roof trusses by fixing spacers, packers, braces and straps. Data loggers are also used to collect equivalent data in a typical floor truss prefabrication line, as illustrated in FIGS. 3 and 4, and in a typical wall frame prefabrication line, as illustrated in FIGS. 6 to 9.

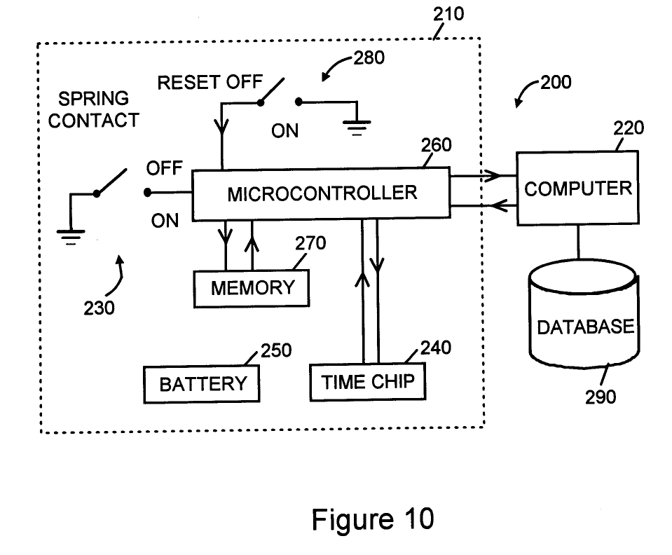

FIG. 10 illustrates one embodiment of a system 200 for implementing the method 100. Referring to FIG. 10, the system 200 generally includes a data logger 210 and a remote computer 220. The data logger 210 includes a sensor 230 to sense signals relating to operation of a machine and/or work station used in the truss and/or frame production line. The sensor 230 is, for example, a spring contact that senses making and breaking of electrical contact when a spring is compressed and uncompressed. One or more other sensors may also be used, for example, temperature sensors, pressure sensors, force sensors, etc. Additional components of the data logger 210 include a time chip 240 to provide clock/calendar data, a battery 250 to provide power, and a microcontroller 260. The microcontroller 260 is programmed to manipulate sensed signals into time-based production data which is stored in a memory 270. Bidirectional wired and/or wireless data communication takes place between the microprocessor 260 and the computer 220. A reset switch 280 is pressed to display a menu on the computer 220 which enables, for example, downloading of production data, reprogramming of the microcontroller 260, resetting of the memory 270, setting of the clock/calendar, etc. Production data transferred to the computer 220 is stored in a database 290.

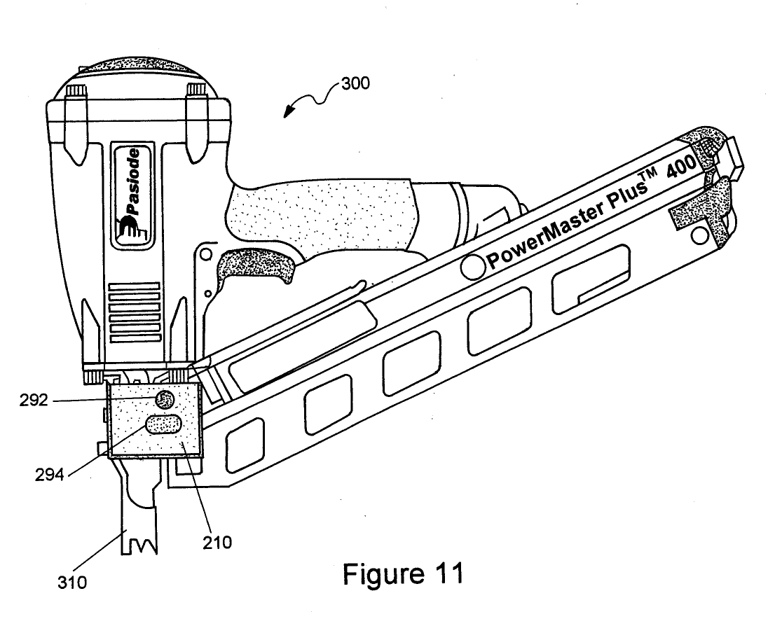

Referring to FIG. 11, the data logger 210 is fitted, for example, to a pneumatic nail gun 300. The nail gun 300 has a sliding safety 310 that compresses a spring (not shown) when the nail gun 300 is pressed against a work piece to make a shot. Compression of the spring causes it to make contact With the spring contact sensor 230 which completes an electrical circuit to transmit a signal to the microcontroller 260. Uncompression of the spring breaks electrical contact and no signal is transmitted.

In use, the data logger 210 collects and stores a clock/calendar-based count of nail shots made by the nail gun 300. As illustrated in FIG. 11, the data logger 210 has a user interface 292, for example, a light emitting diode (LED) which is illuminated to indicate, for example, when a preselected number of shots have been made, or when a maintenance interval has been reached. The stored clock/calendar-based shot count of the nail gun 300 is transferred from the data logger 210 to the remote computer 220 via a data interface 294. As described above, the transferred shot count is stored in a database 290 accessible by the computer 220, and then processed by software executing on the computer to enable analysis of the efficiency of the nail gun 300 in the manufacture of a prefabricated truss and/or frame.

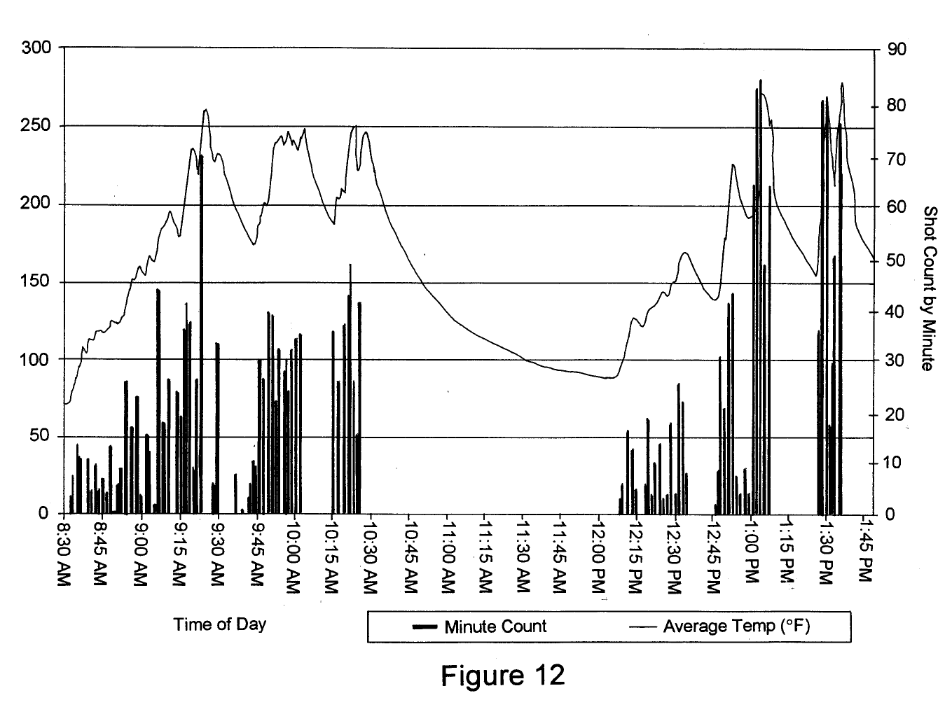

FIG. 12 is an example report generated by the method 100 and system 200 based on one set of production data collected by one data logger 210 for one nail gun 300 when used in a typical truss and/or frame prefabrication line. The report is a graph of temperature, shots per minute, and time logged for the nail gun 300 by the data logger 210.

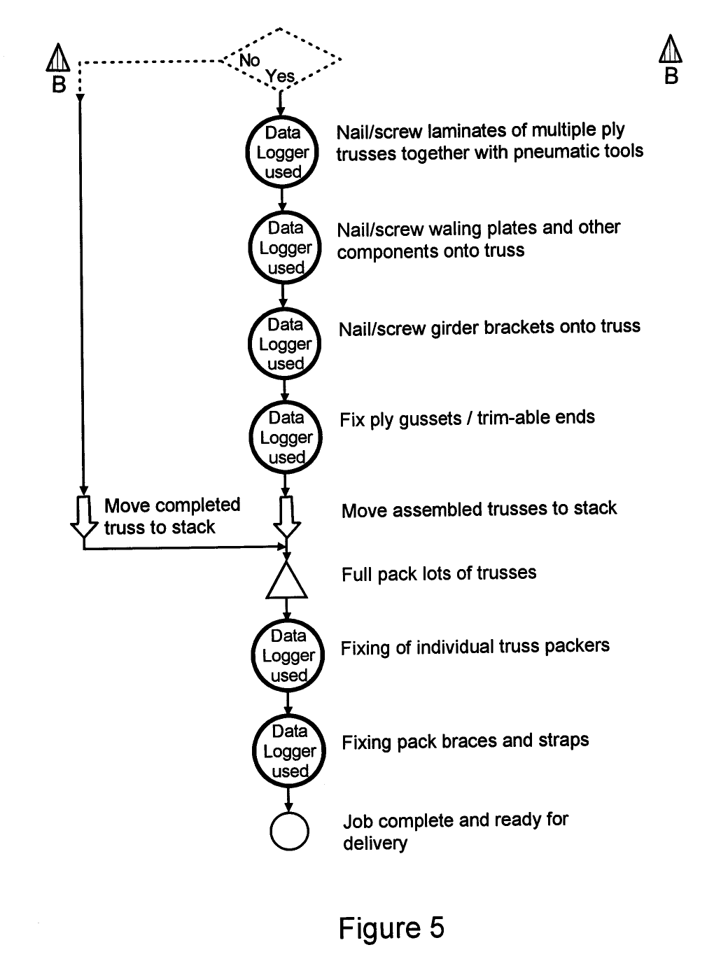

In use, the method 100 collects production data from all data loggers on one of the production lines illustrated in FIGS. 2 to 9, and correlates and evaluates the collected production data against the amount of work completed, and the number of operators working on the lines. The amount of work to be done at each work station on the production line is predetermined from estimating and detailing software, so that variances from the average production rates and from similar work completed in the past highlight opportunities to improve the efficiency of the production line, for example, in the following ways.
Recognising when equipment and/or pneumatic tool maintenance is required.
Recognising when there is an overlap or bottleneck creating lost time for operators.
Recognising when lack of training contributes to reduced operator performance.
Accumulated data can be used prior to the commencement of specific work to recognise when operators may need to be moved to different work stations to match the specific demand.
The cost of the prefabricated components manufactured through truss and frame prefabrication lines comes from the timber, connectors and labour that are used. Usually an increase in the connector usage/cost will result in a decrease in the timber usage/cost and vice versa. However, the labour associated with the different options has been difficult to accurately assess and quite often it is this variation that makes the difference. Accurate optimization of the method of construction is now possible with the use of the data loggers.

The present invention approaches a truss and frame manufacturing operation as a production line that employs a number of people to operate machines and perform primarily manual tasks to cut, assemble and connect together the timber/steel individual components that are parts of larger assemblies that form frames, panels, and trusses that are used in the structure of floors, walls and roofs of buildings. A number of the activities/functions are machine paced and a number are operator paced. The machine paced functions usually have a far higher output capacity than the operators feeding them. Therefore any improvement in the efficiency of the operators in the operation of the machines, or more importantly in the completion of the tasks required to feed the machines, will add to the overall efficiency of the line. The use of the data loggers as described above accurately captures the data for analysis and assessment of the efficiency of the manufacture of prefabricated trusses and/or frames.

Specifically, there is a predetermined amount of time that an operator is employed to be productive and this is usually a 7.5 or 8 hour shift. During this time he may perform a number of different functions or tasks. Even though he may move to different work stations around the factory, the tasks are usually repetitive, involving periods of inactivity for rest and/or downtime, and periods of activity operating a tool or machine or assembly. There are delays, gaps or pauses between periods of activity. The gaps that are acceptable are those that are part of the process, for example, putting an air tool down until the next pieces of wood are being put in the appropriate locations to be fixed together, or transferring a completed assembly from the work station to the next work station.

The gaps that are unacceptable and need to be reduced to increase efficiency are those that are caused by factors outside of the process, for example, out of stock parts or material, equipment malfunctions, lack of training, or several operators having an extended discussion not related to the manufacturing process. The number and magnitude of the unacceptable gaps for each work station may vary depending on the type of work, the experience of the operator, the condition of the equipment and a number of other factors. Each work station in the operation will have an acceptable gap that may vary, and may be different in magnitude to that of any other work station. In practice, it is unlikely that the capacity of each work station remains matched to the others so that the maximum efficiency of the operation is continually achieved. That is why it is critical to have a method and system of data collection analysis that does, for example, the following things.
Records the data from each station. Given the use of the data loggers the feedback can be continuous.
Shows the status of each station.
Shows what a reduction in the unacceptable gap would do for the improvement in productivity of a station.
Shows which is the critical station to focus on to achieve best gain. For example, even though there may be a significant gain in productivity possible at a number of stations in the line it is important to know which of these will have the greatest effect on the overall performance of the line and give it priority. Efficiency and performance in manufacture of a prefabricated truss and/or frame can be either productivity and/or cost effectiveness.
Record the data

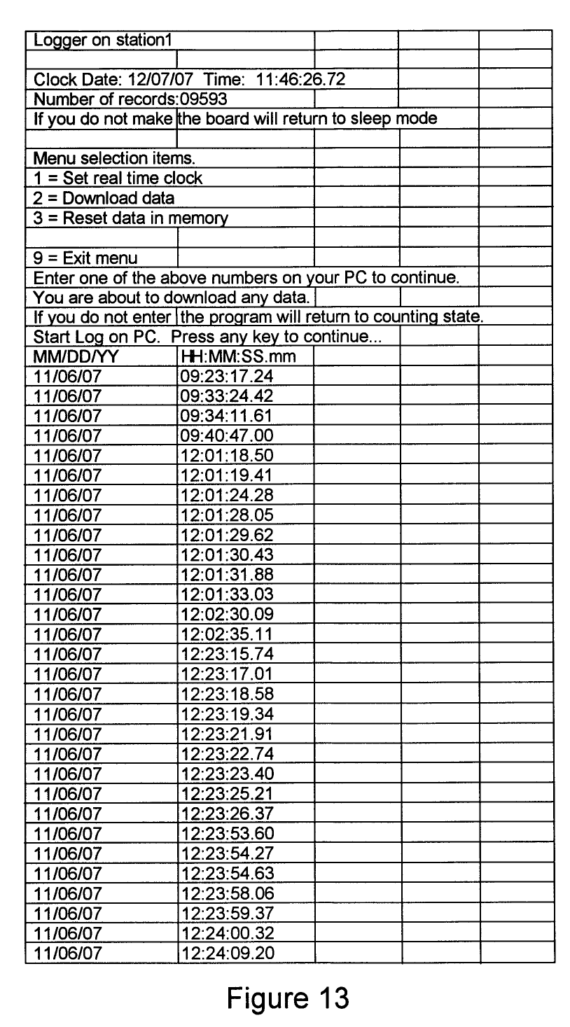

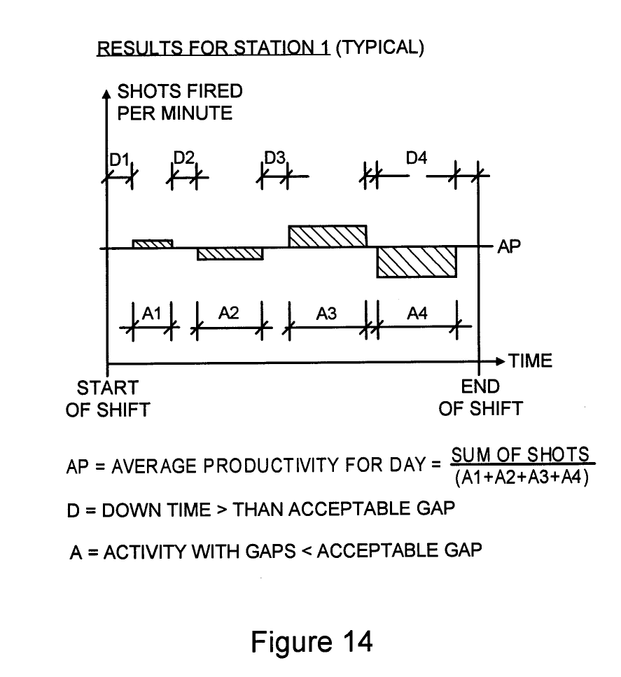

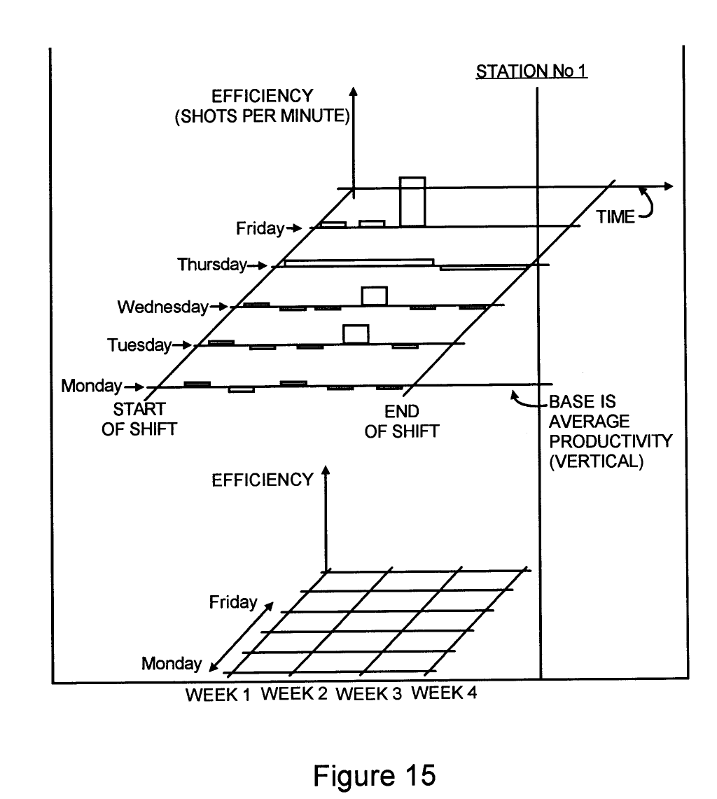

FIGS. 13 to 15 are example screens and reports generated by embodiments of the method 100 and system 200 of the invention. They shows how the collected production data is presented for a typical work station given that the value for an unacceptable gap has been predetermined, for example, derived from the job estimate or detail. This allows production management to see at a glance where unacceptable delays have occurred and allows corrective action to be taken. A drop in efficiency can occur in several ways, for example, either as above where a station records gaps greater that the acceptable limit, or a station does record only unacceptable gaps and is working efficiently but is overloaded or under capacity. In this case, the warning would not be picked up from the particular station but from the stations up-stream and/or down-stream of it in the process. Initially, it could be the immediate stations and then those further away. FIGS. 14 and 15 show a number of different ways of presenting the collected production data in an at-a-glance format that highlights unacceptable gaps, trends, anomalies, etc. Production data can be represented in this form for a number of linked or subsequent stations in a production line so as to give a better overall picture of production efficiency in the manufacturing line.

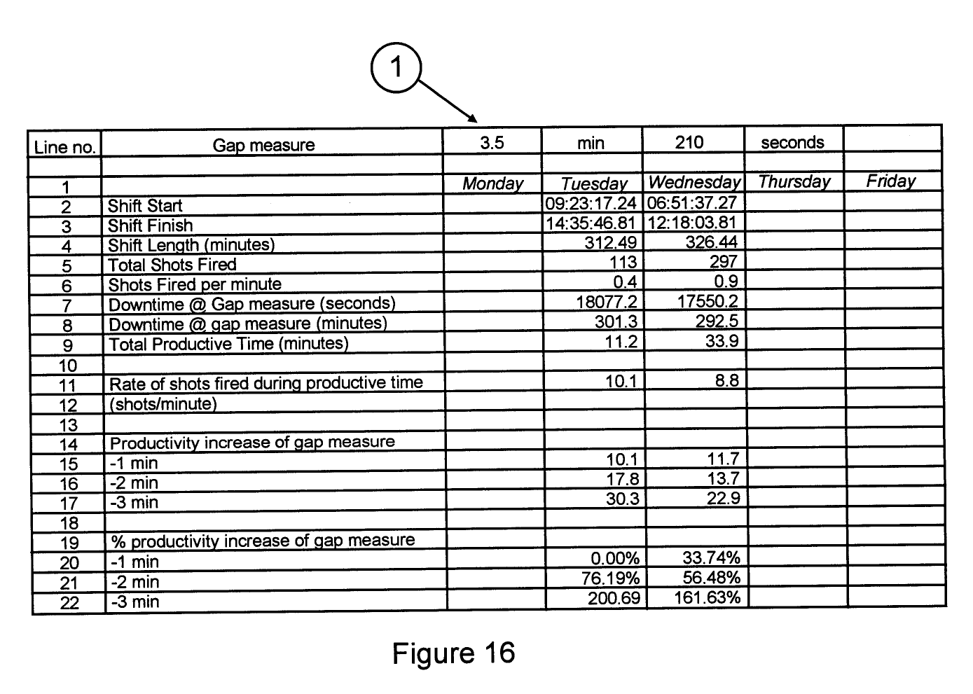

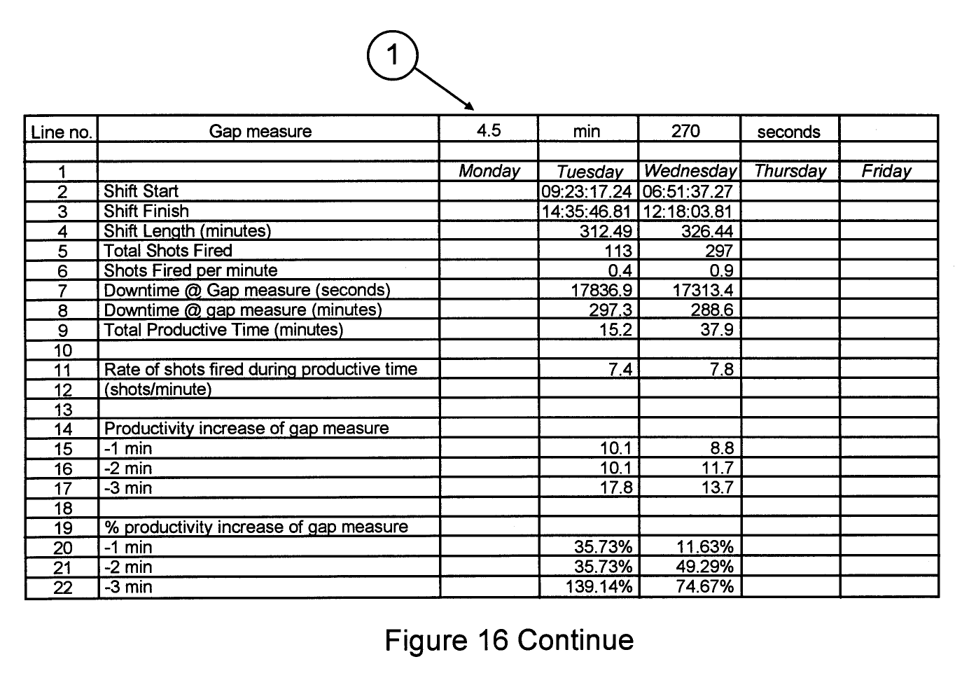

FIG. 16 are example data tables showing how the collected production data can be used to reduce, remove or ameliorate unacceptable and inefficient gaps in prefabricated truss and/or frame production lines. The shaded cell indicated by the reference numeral 1 is a measure of an undesirable gap (or “gap measure”) in minutes and seconds. The value of the unacceptable gap is changed from 3.5 minutes in the upper table to 4.5 minutes in the lower table, the production data is automatically re-evaluated, and productivity is recalculated at line 9 of the tables. There is a cost to complete each cycle or shot at each station, and this is used to assess the benefit of any changes, or if it is going to be cost effective, or if increasing the incentive for the operator is going to be cost effective. Lines 20, 21, and 22 of the tables show calculated increases in efficiency that can be gained by dropping the value of the unacceptable gap in preselected increments. These potential efficiency increases can be calculated across all machines and/or work stations in the production line so as to highlight those points in the production line where most gains in efficiency can be made.

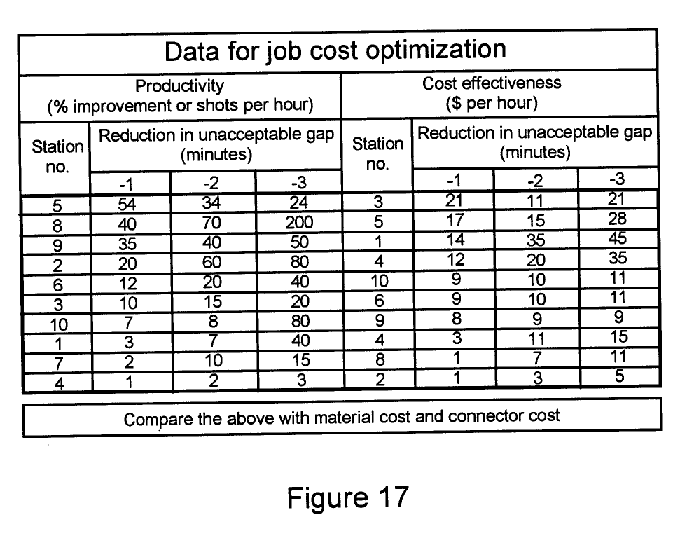

FIG. 17 is an example data table that associates delay with productivity and cost. The costs associated with each work station are predetermined and can be calculated accurately for the different circumstances, for example, number of men, type of work, etc. The table of FIG. 17 associates cost effectiveness in dollars per hour with unacceptable gaps in minutes identified by analysis of the collected production data. The table identifies work stations in the production line where efficiencies can be improved, together with the associated cost savings. This information enables decisions to be made about whether productivity or cost effectiveness should be prioritised. For example, two lists could be calculated in ascending order, one list showing productivity and the other showing cost effectiveness. The cost of the connectors and components of the prefabricated truss and/or frame are predetermined from the job estimate and detail. This information can be used with the two lists to enable accurate optimisation of production efficiency by indicating which option will provide the production line/plant which production changes are beneficial with the best return.

Embodiments of the present invention therefore provide a solution that to optimise efficiency in the manufacture of prefabricated trusses and frames. Specifically, embodiments identify bottlenecks in the manufacturing production line so that efficiency improvements relating to productivity, delay, cost and waste can be determined and implemented.

The embodiments have been described by way of example only and modifications are possible within the scope of the claims which follow.

1. A method for managing production of prefabricated trusses and frames, the method including the steps of collecting production data during manufacture of a prefabricated truss and/or -frame, storing the collected production data, and processing the stored production data to enable analysis of efficiency in the manufacture of the prefabricated truss and/or frame.

2. A method according to claim 1, further including the step of determining at least one improvement in the manufacture of the prefabricated truss and/or frame based at least in part on the processed production data.

3. A method according to claim 1, wherein the production data is selected from time-based data, event-based data, activity-based data, usage-based data, and combinations thereof.

4. A method according to claim 1, wherein the production data relates to at least one of productivity, delay, waste, and cost.

5. A system for managing production of prefabricated trusses and frames, the system including at least one data logger to collect production data during manufacture of a prefabricated truss and/or frame, a database to receive and store the collected production data, and a computer programmed to access and process the stored production data to enable analysis of efficiency in the manufacture of the prefabricated truss and/or frame.

6. A system according to claim 5, wherein the at least one data logger collects production data from at least one machine and/or at least one work station used during the manufacture of the prefabricated truss and/or frame.

7. A system according to claim 6, wherein the at least one machine is selected from a-fastener-driving tool, a saw, a roller, and a press.

8. A system according to claim 7, wherein the at least one work station is a jig or an assembly table.
